(19) United States
(12) Patent Application Publication
(10) Pub. No.: US 2016/0054620 A1
(43) Pub. Date: Feb. 25, 2016

(54) COLOR FILTER SUBSTRATE AND FABRICATION METHOD THEREOF, DISPLAY PANEL AND DISPLAY DEVICE

(71) Applicants: BOE TECHNOLOGY GROUP CO., LTD., BEIJING (CN); BEIJING BOE DISPLAY TECHNOLOGY CO., LTD., BEIJING (CN)

(72) Inventors: MINGCHAO WANG, BEIJING (CN); HONGTAO LIN, BEIJING (CN); JUNWEI WANG, BEIJING (CN)

(21) Appl. No.: 14/382,350

(22) PCT Filed: Jun. 26, 2013
(86) PCT No.: PCT/CN2013/077945

§ 371 Date: Sep. 2, 2014

(30) Foreign Application Priority Data
Mar. 22, 2013 (CN) 201310094769.X

(51) Int. Cl. G02F 1/1335; G02F 1/1339; G02B 5/20

(52) U.S. Cl. CPC G02F 1/133514; G02B 5/201; G02F 1/133516; G02F 1/13394

(57) ABSTRACT

Embodiments of the disclosure provide a color filter substrate and a fabrication method thereof, a display panel and a display device. The color filter substrate comprises a base substrate (4) and a plurality of color filter units (3) disposed on the base substrate (4). The color filter substrate further comprises a mark structure (6) for marking a coordinate of a pixel corresponding to the color filter unit (3).

### TECHNICAL FIELD

Embodiments of the disclosure relate to a color filter substrate and a fabrication method thereof, a display panel and a display device.

### BACKGROUND

With development of production line of Thin Film Transistor Liquid Crystal Display (TFT-LCD) and increase of size of display panel, the probability of occurrence of various defects increases as well. During repairing the display panel and analyzing the defects of the display panel, precise positioning of pixels has become a significant problem. In particular, in the case that a scanning electron microscope, a 3D microscope, an atomic-force microscopy, or an infrared spectrometer, etc. is used to analysis the display panel, the panel needs to be cut in a sample preparation process, then how to ensure precise positioning of pixels before and after cutting has become a serious problem. In addition, some instruments cannot distinguish colors, so it is more difficult to determine the pixels to be studied (especially for a color filter substrate), and how to solve this problem has been very important.

At present, the positioning of pixels on display panel is achieved by a method using a relative coordinate, in which the panel is placed on a base platform of an instrument, the coordinate of defect is recorded, and then the defect is analyzed and repaired. However, there are obvious disadvantages of this method. Firstly, when the relative coordinate is used, disordered positioning is apt to occur after the panel leaves the base platform of the instrument; secondly, the relative coordinate of a large-sized panel cannot be obtained on a small base platform of some analytical instruments (such as SEM/3D OM); thirdly, if a laser mark is made in the vicinity of the defect by using the relative coordinate, the features of the defect may be affected.

### SUMMARY

According to embodiments of the disclosure, there is provided a color filter substrate. The color filter substrate comprises a base substrate and a plurality of color filter units disposed on the base substrate. The color filter substrate further comprises a mark structure for marking a coordinate of a pixel corresponding to the color filter unit.

According to embodiments of the disclosure, there is further provided a method of fabricating a color filter substrate. The method comprises steps of: forming a color filter unit on a base substrate; and forming a mark structure for marking a coordinate of a pixel corresponding to the color filter unit.

According to embodiments of the disclosure, there is further provided a display panel. The display panel comprises the above-described color filter substrate.

According to embodiments of the disclosure, there is further provided a display device. The display device comprises the above-described display panel.

### BRIEF DESCRIPTION OF THE DRAWINGS

FIG. 1 shows a top view of a color filter substrate according to embodiments of the disclosure;

FIG. 2 shows a cross-sectional view of the color filter substrate according to embodiments of the disclosure, which is taken along line A-A;

FIG. 3 shows a cross-sectional view of the color filter substrate according to embodiments of the disclosure, which is taken along line B-B;

FIG. 4 shows a top view after a first step in fabricating a color filter substrate according to embodiments of the disclosure;

FIG. 5 shows a cross-sectional view after the first step in fabricating the color filter substrate according to embodiments of the disclosure, which is taken along line A-A;

FIG. 6 shows a cross-sectional view after the first step in fabricating the color filter substrate according to embodiments of the disclosure, which is taken along line B-B;

FIG. 7 shows cross-sectional view after a second step in fabricating the color filter substrate according to embodiments of the disclosure, which is taken along line A-A;

FIG. 8 shows a cross-sectional view after the second step in fabricating the color filter substrate according to embodiments of the disclosure, which is taken along line B-B;

FIG. 9 shows a cross-sectional view after a third step in fabricating the color filter substrate according to embodiments of the disclosure, which is taken along line A-A;

FIG. 10 shows a cross-sectional view after the third step in fabricating the color filter substrate according to embodiments of the disclosure, which is taken along line B-B;

FIG. 11 shows a cross-sectional view after a fourth step in fabricating the color filter substrate according to embodiments of the disclosure, which is taken along line A-A; and

FIG. 12 shows a cross-sectional view after the fourth step in fabricating the color filter substrate according to embodiments of the disclosure, which is taken along line B-B.

### DESCRIPTION OF THE EMBODIMENTS

Embodiments of the disclosure will be described in detail below in conjunction with the accompanying drawings, and the described embodiments only serve to illustrate principles of the disclosure, other than limit the disclosure.

The following description is mainly made for a single pixel, but other pixels may have the same structure or may be formed in the same manner.

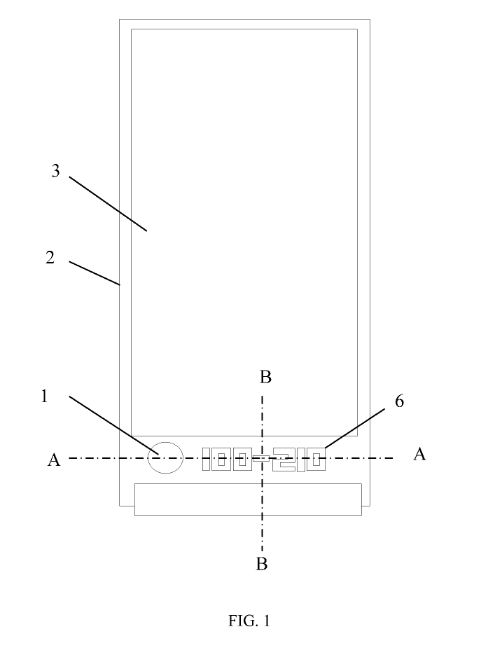

Embodiments of the disclosure provide a color filter substrate. As shown in FIGS. 1-3, the color filter substrate comprises a base substrate 4 and a plurality of color filter units 3 disposed on the base substrate 4, the color filter substrate further comprises a mark structure 6 for marking a coordinate of a pixel corresponding to the color filter unit.

An absolute coordinate of the pixel is achieved by the mark structure 6, which marks coordinate in a periphery of the pixel (i.e., the pixel to be marked) corresponding to the color filter unit of the color filter substrate. Accordingly, no matter which instrument's base platform is used and whether the substrate is cut or not, it is possible to rapidly and accurately find the defect and position it, so the efficiency and accuracy of repair and analysis are improved.

For example, the pixel is a sub-pixel corresponding to a single color filter unit, or a combination of sub-pixels corresponding to a combination of several color filter units. Preferably, the pixel is the sub-pixel corresponding to the single color filter unit.

The mark structure 6 comprises a row number mark. The row number mark indicates a row number of a row along a first direction where the color filter unit is located, or indicates a shared row number of a plurality of adjacent rows along the first direction where adjacent color filter units are located.

The mark structure 6 further comprises a column number mark. The column number mark indicates a column number of a column along a second direction where the color filter unit is located, or indicates a shared column number of a plurality of adjacent columns along the second direction where adjacent color filter units are located.

For example, the first direction and the second direction are perpendicular to each other.

For example, the mark structure 6 comprises the row number mark and the column number mark, the row number mark indicates a row number of a gate line corresponding to the color filter unit, and the column number mark indicates a column number of a data line corresponding to the color filter unit.

For example, the mark structure 6 is disposed at any position in a periphery of the color filter unit.

For example, the mark structure 6 is provided within a region corresponding to the gate line which corresponds to the color filter unit.

For example, the color filter substrate further comprises a spacer 1, and the mark structure 6 and the spacer 1 are formed in a same layer.

For example, the spacer 1 is a columnar spacer, and the columnar spacer and the mark structure 6 are simultaneously formed of a same material through a same patterning process.

For example, the color filter substrate further comprises a black matrix, and the mark structure 6 is formed within a region corresponding to the black matrix.

For example, the mark structure 6 comprises a number, a letter or a combination thereof. However, the form of the mark structure is not limited thereto.

FIGS. 1-3 exemplarily illustrate a color filter substrate of a Twisted Nematic (TN) display mode, and the color filter substrate of the TN display mode does not have a planarization layer. According to the embodiments of the disclosure, in the color filter substrate, the row and column marks are marked for a sub-pixel through a patterning process for example by using a material same as that of the spacer on the black matrix in the direction of the gate line. In FIG. 1-FIG. 3, for example, the mark structure 6 is “100-210”, where “100” represents the row number of the gate line, and “210” represents the column number of the data line.

Embodiments of the disclosure further provides a method of fabricating a color filter substrate, and the method comprises steps of: forming a color filter unit on a base substrate; and forming a mark structure for marking a coordinate of a pixel corresponding to the color filter unit 3.

For example, the step of forming the color filter unit on the base substrate comprises: forming a black matrix through a patterning process; and forming the color filter unit through a patterning process.

For example, the method further comprises: forming a spacer on the base substrate on which the color filter unit and the black matrix are formed.

The step of forming the mark structure for marking the coordinate of the pixel corresponding to the color filter unit comprises: forming the mark structure and the spacer simultaneously through a patterning process.

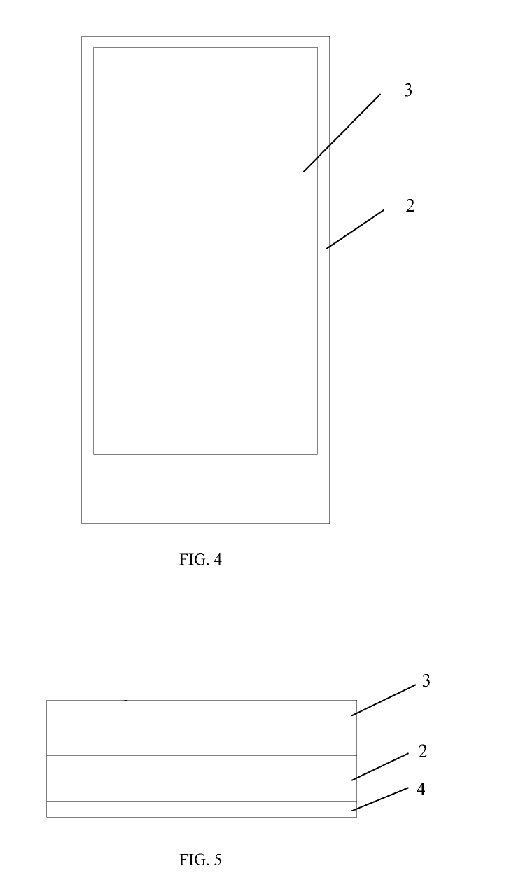

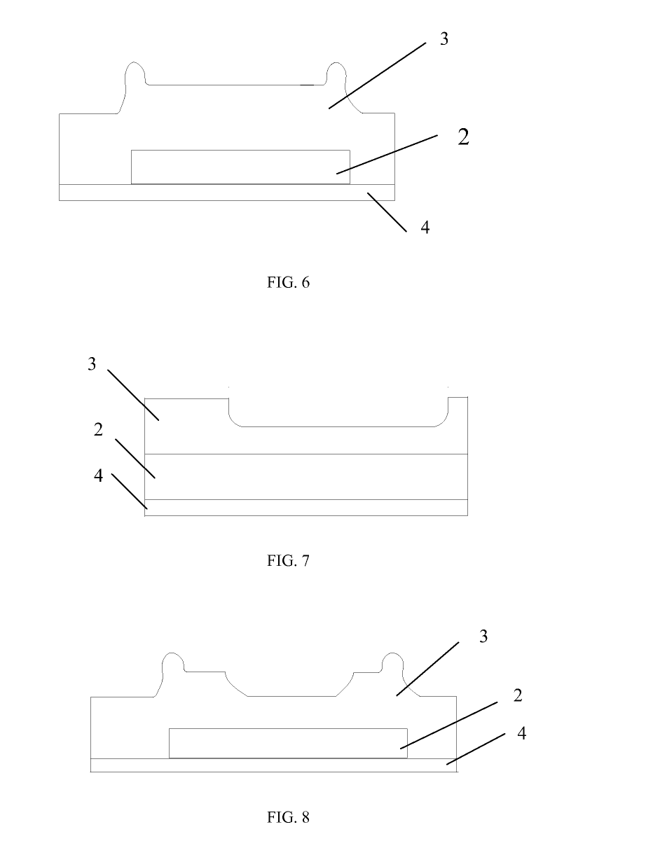

Hereinafter, the method of fabricating the color filter substrate according to embodiments of the disclosure will be described in detail in conjunction with FIGS. 4-12.

Step 1: forming the black matrix 2 and the color filter unit 3 sequentially on the base substrate 4, as shown in FIG. 4-FIG. 6.

Step 2: reducing a thickness of a portion of the color filter unit 3 corresponding to a region for forming the mark structure (e.g. such region is within a region corresponding the gate line) by using a semi-exposure method, so that the thickness of the portion of the color filter unit 3 corresponding to the region for forming the mark structure is smaller than a thickness of other portions of the color filter unit, as shown in FIG. 7 and FIG. 8.

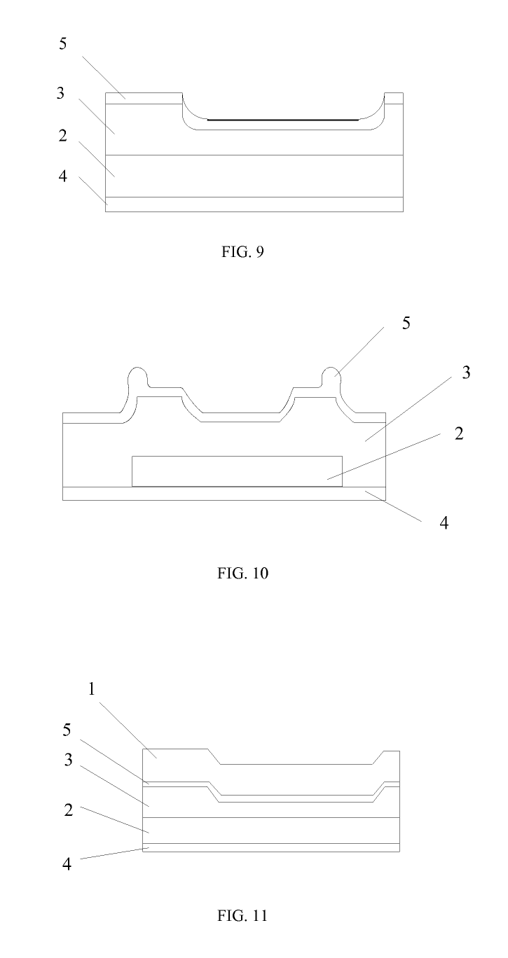

Step 3: depositing a common electrode layer 5 on the color filter unit 3, as shown in FIG. 9 and FIG. 10. The common electrode layer is for example made of ITO.

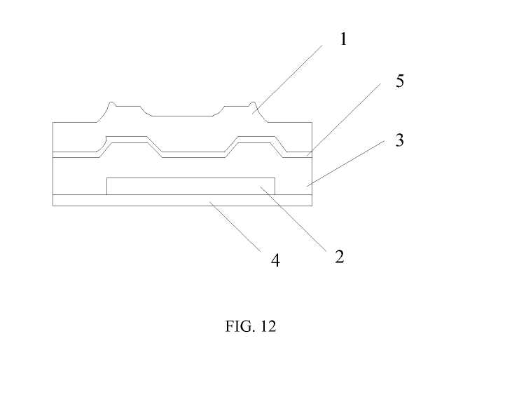

Step 4: depositing a spacer layer on the common electrode layer 5, as shown in FIG. 11 and FIG. 12.

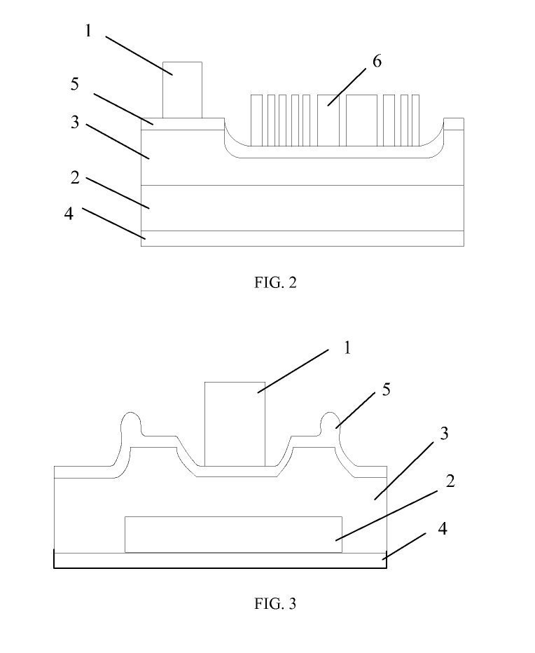

Step 5: patterning the spacer layer to form the spacer and the mark structure, to complete the fabrication of the color filter substrate, as shown in FIG. 1-FIG 3.

According to the embodiments of the disclosure, the absolute coordinate of the pixel is marked. By marking the absolute coordinate of the pixel on the color filter substrate, the problem that the pixels of large-sized display panel can not be accurately positioned is solved, and meanwhile the problem that the color filter units corresponding to red, green and blue pixels are difficultly distinguished in some analytical instruments (for example, an optical microscope (OM), a scanning electron microscope (SEM), or a 3D microscope). Thus, the position of the defect is easily determined during repairing and analyzing the defect, and the efficiency and accuracy in repairing and analyzing the defect are effectively enhanced.

Those skilled in the art should understand that, the mark structure for marking the coordinate of the pixel corresponding to the color filter unit is not limited to be provided at the above-described position. In addition, the mark structure is not limited to comprise the row number and the column number; and the mark structure can be achieved in any other form. The order of the steps in the method of fabricating the color filter substrate is not limited to the above-described order, and other equivalents thereof are not enumerated herein.

Embodiments of the disclosure further provide a display panel. The display panel comprises a color filter substrate as described above. The display panel for example further comprises an array substrate and a liquid crystal layer, the liquid crystal layer is filled between the color filter substrate and the array substrate.

Embodiments of the disclosure further provide a display device. The display device comprises a display panel as described above. For example, the display device further comprises other components such as a backlight.

The foregoing embodiments merely are exemplary embodiments of the invention, and not intended to define the scope of the invention, and the scope of the invention is determined by the appended claims.

1. A color filter substrate, comprising a base substrate and a plurality of color filter units disposed on the base substrate, wherein the color filter substrate further comprises a mark structure for marking a coordinate of a pixel corresponding to the color filter unit.

2. The color filter substrate according to claim 1, wherein the mark structure comprises a row number mark; and
the row number mark indicates a row number of a row along a first direction where the color filter unit is located, or indicates a shared row number of a plurality of adjacent rows along the first direction where adjacent color filter units are located.

3. The color filter substrate according to claim 2, wherein the mark structure further comprises a column number mark;
the column number mark indicates a column number of a column along a second direction where the color filter unit is located, or indicates a shared column number of a plurality of adjacent columns along the second direction where adjacent color filter units are located; and
the first direction and the second direction are perpendicular to each other.

4. The color filter substrate according to claim 1, wherein the mark structure is disposed in a periphery of the color filter unit.

5. The color filter substrate according to claim 1, wherein the color filter substrate further comprises a spacer, and the mark structure and the spacer are formed in a same layer.

6. The color filter substrate according to claim 1, wherein the pixel is a sub-pixel.

7. The color filter substrate according to claim 6, wherein the spacer is a columnar spacer, and the columnar spacer and the mark structure are simultaneously made of a same material through a same patterning process.

8. The color filter substrate according to claim 1, wherein the mark structure comprises a number, a letter or a combination thereof.

9. The color filter substrate according to claim 1, wherein the color filter substrate further comprises a black matrix, and the mark structure is formed within a region corresponding to the black matrix.

10. A method of fabricating a color filter substrate, comprising steps of:
forming a color filter unit on a base substrate; and
forming a mark structure for marking a coordinate of a pixel corresponding to the color filter unit.

11. The method of fabricating a color filter substrate according to claim 10, wherein the step of forming the color filter unit on the base substrate comprises:
forming a black matrix through a patterning process; and
forming the color filter unit through a patterning process.

12. The method of fabricating the color filter substrate according to claim 11, wherein the method further comprises:
forming a spacer layer on the base substrate on which the color filter unit and the black matrix are formed; and
patterning the spacer layer to simultaneously form the spacer and the mark structure.

13. A display panel, comprising the color filter substrate according to claim 1.

14. (canceled)

15. The method of fabricating the color filter substrate according to claim 11, comprising:
forming the black matrix and the color filter unit sequentially on the base substrate;
reducing a thickness of a portion of the color filter unit corresponding to a region for forming the mark structure by using a semi-exposure method, so that the thickness of the portion of the color filter unit corresponding to the region for forming the mark structure is smaller than a thickness of other portions of the color filter unit;
forming a common electrode layer on the color filter unit;
forming a spacer layer on the common electrode layer; and
patterning the spacer layer to form the spacer and the mark structure.

16. The display panel according to claim 13, further comprising an array substrate facing the color filter substrate, wherein
the array substrate comprises a gate line and a data line intersecting with each other; and
the mark structure is provided within a region corresponding to the gate line and/or the data line corresponding to the color filter unit.

17. The display panel according to claim 16, wherein the mark structure comprises a row number mark and a column number mark, the row number mark indicates a row number of the gate line corresponding to the color filter unit, and the column number mark indicates a column number of the data line corresponding to the color filter unit.
